(19) United States
(12) Patent Application Publication
(10) Pub. No.: US 2002/0010660 A1
(43) Pub. Date: Jan. 24, 2002

(54) Hosting service system of household account information, household account server, account information providing server, household account information processing server, and method for providing household account information using network and storage medium

(75) Inventors: Yuhichi Nakamura, Yokohama-shi (JP); Kazuyoshi Hidaka, Yokohama-shi (JP); Naohiko Uramoto, Yokohama-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 09/853,170

(22) Filed: May 10, 2001

(30) Foreign Application Priority Data
Jun. 30, 2000 (JP) 2000-199021

(51) Int. Cl. G06F 17/60

(52) U.S. Cl. 705/28

(57) ABSTRACT

A method and system to save a user (customer) the trouble of management, with the user leaving his own household account information with the server's side, while a financial institution corresponding to a server makes active use of customer's household account information for advertisement.

A hosting service system of household account information comprises a user terminal 8 connected to a network; and a service provider (financial institute) 10 connected to the network for providing the user terminal 8 with household account information 12 including a plurality of items for each user, wherein the service provider (financial institute) 10 generates additional information at the information processing module 15 based on the analysis results regarding the household account information 12, and adds the additional information to predetermined items in the household account information 12 of each user and provides to the user terminal 8.

### DETAILED DESCRIPTION OF THE INVENTION

1. Field of the Invention

The present invention relates to a management system for personal household account information, and more particularly to a system for providing household account information to a user as a hosting service.

2. Background Art

In recent years, due to the introduction of the Big Ban liberalization of the financial sector, various financial products have been provided, so it is assumed that personal asset management becomes increasingly complicated. Also, many of the holders of a personal computer are performing asset management using a personal computer or hoping to do that, thus it is widely desired that an individual unitarily manage income and expenditure of an account, cope with various financial products, and manage own asset easily with a personal computer or the like.

FIG. 18(a) and (b) is a diagram illustrating an outline of a conventional household account system. As is shown in FIG. 18(a), Japanese Unexamined Patent Publication No. 1997-277750 discloses a technique, wherein data is downloaded from an account system 302 or ATM and entered in a customer's household account book 301. Also, as for a personal finance management software “Money” from Microsoft, a household account system 303 installed in a personal computer of an individual as a program can download data from a remote account system 304 over a network, as is shown in FIG. 18(b).

### Problems to be Solved by the Invention

However, with a technique disclosed in the above Japanese Unexamined Patent Publication No. 1997-277750, only entering in a passbook is enabled and a user (i.e., customer) can not directly edit data. A bank can not view what has been edited, either, so information simply flows in one direction from a bank to a user.

As for Microsoft's “Money”, although a function for planning and advice for money management is substantial, however, in terms of information flow, it is one-way from a bank to a user as well, so the bank as a financial institution can not make use of edited information. Moreover, along with maintenance of a software, management of data is entrusted to a user, thus there is a problem in terms of convenience. In addition, for a financial institute that provides information, though there is expected acquisition of customers due to the improvement of services, there is a little profit, thus some of them hesitate to provide data.

The present invention is provided to solve the above problems, therefor, it is an object of the present invention to save a user (customer) the trouble of management, with the user leaving his own household account information with the server's side.

It is another object of the invention that a financial institution or the like corresponding to a server's side that provides household information makes active use of customer's household account information for advertisement.

### SUMMARY OF THE INVENTION

In view of these objects, in one aspect of the present invention, a system for managing household account information operates on the server's side, wherein the household account information is provided from the server's side to a customer, in addition, there is added a feature for utilizing the household account information for marketing. This allows improvement of convenience for a user, as well as an analysis by a financial institute from various points of view, thereby providing an effective scheme for both users and financial institutes. That is, a hosting service system of household account information according to the present invention comprises a user terminal connected to a network; and a service provider connected to the network for providing the user terminal with household account information including a plurality of items for each user, wherein the service provider adds additional information to predetermined items in the household account information of each user and provides to the user terminal, wherein the additional information is based on the analysis results regarding the household account information.

The system further comprises an information processing module □□ for analyzing this household account information and providing additional information such as an advertisement and advice based on the analysis results. A service provider such as a financial institute could have this information processing module.

Alternatively, this information processing module may be provided by an information processing company that is connected to the service provider over a network, which allows adding additional information such as an advertisement for marketing to household account information, wherein a service provider doesn't need to provide the function itself.

Furthermore, the household account information provided by the service provider has its contents of a plurality of items updated on the basis of a change of contents in bank account information of each user, whereby the household account information is provided based on the latest bank account information.

In addition, the service provider may provide household account information, wherein income and expenditure items are subdivided on the basis of a request from the user terminal, and send a predetermined notice to the user terminal on the basis of set notification conditions from the user terminal, thereby providing a useful service to a user (customer).

In another aspect of the invention, there is provided a household account server for providing household account information to a user terminal connected to a network, comprising: an account information updating feature for updating account information in response to update of bank account data and reflecting in the household account information; an information adding feature for adding information to the household account information in response to additional information about marketing; and a notification feature for notifying the account information updated by the account information updating feature and the information added by the information adding feature to the user terminal. The additional information about marketing may be created by the household account server itself, or transmitted by any others over a network. That is, the household account server further comprises an information processing module for analyzing the household account information and generating additional information about an advertisement, wherein the information adding feature adds the information generated by the information processing module to the household account information. Alternatively, the information adding feature may add information about an advertisement that is created by an external institute connected via network as analysis results of the household account information to the household account information. Note that the term “advertisement” contains various kinds of contents such as a commercial, which include a set of information about marketing.

In a further aspect of the invention, there is provided an account information providing server for providing managed account information to a user terminal connected to a network, comprising: view request accepting means for accepting a view request from the user terminal; notification conditions accepting means for accepting the setting of notification conditions from the user terminal; and account information providing means for providing the account information to the user terminal on the basis of the view request accepted by the notification conditions accepting means and for providing the account information to the user terminal if it matches the notification conditions accepted by the notification conditions accepting means. The server further comprises adding means for adding advertisement information to the account information as a result of an analysis of the account information, wherein the account information providing means provides the account information added with the advertisement information to the user terminal, thereby allowing the server's side that provides account information to utilize for marketing or the like.

In a further aspect of the invention, there is provided a household account information processing server, comprising: acquiring means for acquiring household account information from a server that holds household account information; analyzing means for analyzing the acquired household account information; determining means for determining additional information to be added to the household account information on the basis of analysis results by the analyzing means; and output means for outputting the additional information determined by the determining means to the server. This additional information includes, for example, advice information for building up assets by a financial planner as well as advertisement information.

In a further aspect of the invention, there is provided a method for providing household account information to a user terminal connected to a network using the network, comprising the steps of: generating household account information on the basis of bank account information of each user; adding additional information such as advertisement information to items held by the household account information, wherein the additional information is based on an analysis of the generated household account information; and providing the household account information with the items of the additional information added to the user terminal.

The step of generating household account information further comprises the steps of: subdividing income and expenditure items from the bank account information to generate household account information; and providing the generated household account information to the user terminal on the basis of a view request from the user terminal.

The method further comprises the steps of: accepting notification conditions set by the user terminal; and sending a notice to the user terminal if the household account information matches the accepted notification conditions. The method further comprises the steps of: providing the household account information to an information processing company connected over a network; receiving advertisement information generated by the information processing company on the basis of an analysis of the household account information; and adding the received advertisement information to items held by the household account information.

In addition, the method further comprises the steps of: acquiring information from other financial institutions such as a credit company over a network; and generating household account information on the basis of the acquired information, thereby making the household account information more satisfactory.

In a further aspect of the invention, there is provided a storage medium storing a program readable by input means of a computer and executed by the computer, the program comprising: processing for generating household account information wherein income and expenditure items are subdivided on the basis of bank account information; processing for adding additional information such as advertisement information to the household account information on the basis of an analysis of the generated household account information; and processing for providing the household account information with the additional information added to the user terminal. The program further comprises: processing for accepting notification conditions from the user terminal; and processing for sending a notice to the user terminal if the household account information matches the accepted notification conditions.

In a further aspect of the invention, there is provided a storage medium storing a program readable by input means of a computer and executed by the computer, the program comprising: processing for acquiring household account information from a household account server that holds household account information; processing for analyzing the acquired household account information; processing for determining additional information to be added to the household account information such as advertisement information and advice on the basis of analysis results; and processing for outputting the determined additional information to the household account server.

The above storage medium includes a medium such as a CD-ROM, for example, which stores a software for performing these processing. In the embodiment where a program is downloaded via network, the present invention also contemplates a medium in a transmission device of a program and a storage medium such as a hard disk after downloading.

### Preferred Embodiments

Now the present invention will be described in reference to the attached drawings.

FIG. 1 is a diagram illustrating an overall configuration of a household account system according to the present invention. In FIG. 1, a symbol 8 is a user terminal that is composed of a personal computer (PC) connected to a network such as the Internet, comprising a browser serving as software for viewing home pages on WWW (World Wide Web) servers in the Internet, and a mail function for sending, receiving and managing an e-mail. A symbol 10 is a financial institute serving as a service provider, which provides various kinds of household account information to a user terminal 8 connected to a network such as the Internet.

The service provider 10 comprises a household account server 11, household account information 12, an account system 13, bank accounts 14, and an information processing module 15. The household account server 11 manages the household account information 12 and further manages interactions with other modules, thus being a key module of the embodiment of the present invention. The household account information 12 stores individual information according a predetermined data format. The account system 13 is a system that manages accounts of customers, managing deposits of customers on the basis of bank account information stored in the bank accounts 14 and providing information periodically to the household account server 11, which forms the foundation of the household accounts. The information processing module 15 reads the household account information from the household account server 11, processes its contents and transfers obtained new information to the household account server 11. A customer using the user terminal 8 accesses the household account server 11 via network to view and update the household account information 12 and further receives notification from the household account server 11. The household account information 12 which the user terminal 8 receives is far more detailed information than booked information in a regular passbook. Booking a passbook involves received money, payment, the balance, and a few lines of remarks at most, whereas the household account information 12 is able to show total amounts of income and expenditure separately for a given period of time (e.g., one month). In addition, by automatic debt transfer with a cash-card, not only the total amounts but also individual items of expenses and date and time information can be added.

FIG. 2 is a diagram illustrating a modification of the household account system shown in FIG. 1. The information processing module 15, which was provided by the financial institute serving as a service provider 10 in FIG. 1, is in turn provided by a third party serving as an information processing company 20 via network such as the Internet in FIG. 2. Also, the household account server 11 of the service provider 10 can receive updated data from a credit company 21 that is any other financial institute and update the household account information 12. Making use of data from the credit company 21, a wide range of rich information can be obtained. According the embodiment of the present invention, on the assumption that an financial institute provides detailed items of income and expenditure, the convenience is improved for a user. This results in getting information about which goods each user purchases. The financial institute serving as a service provider 10 can make a profit by making the third party serving as the information processing company 20 utilize this information. On the other hand, the information processing company 20 also can earn profits for the good reason that it can provide an appropriate advertisement on the basis of the obtained high quality information. However, the information provided to the information processing module 15 should not include information that identifies customers such as names of certain customers, in order not to intrude on their privacy.

In this way, according to the embodiment of the invention, by means of hosting (i.e., a service for an Internet provider to lend out network resources to a user for convenience), the service provider 1 0 provides the household account information 12 to the user terminal 8. Furthermore, in addition to a framework hosting this household account system, there is provided an information processing module 15, which analyzes the household account information 12 and reflects a new information (e.g., advertisement) based on the household account information 12 in the household accounts. A user sees this advertisement while viewing or editing the household account information 12.

FIG. 3 depicts a data format of household account information stored in the household account information 12. Here is shown the household account information of one user, wherein the household account data is created in reference to the regular household accounts. This household account data consists of a plurality of listed items, total expenditure, total income, carry-over, etc. Each item comprises the expenditure and income that distinguishes between expenditures and incomes, amount of money, and date fields. There are also provided a plurality of classes as an attribute that arranges each item hierarchically, wherein three classes are provided here. In addition, each item is allocated a payment method including by automatic debt transfer, at a convenience shop and in cash, etc., and an advertisement field serving as a field for a financial institute to use for advertisement, which comprises the feature of the present invention. As to the total expenditure of the household account data, for example, there are provided totals for each class, wherein the class expenditure includes food expenses, light and fuel expenses, a telephone bill, and drink money. In this way, according to the present invention, the convenience for a user who is provided with the household account information 12 is improved by subdividing the income and expenditure items. Likewise, for a financial institute utilizing this household account information 12, its analysis becomes possible from various points of view.

FIG. 4 depicts a data format of bank account information stored in the bank accounts 14. The account information data stored in the bank accounts 14 consists of a plurality of items, wherein each item comprises the distinction between expenditure and income, amount of money, and date information. Moreover, each item comprises special notes such as public utility charges and a salary deposit.

FIG. 5 depicts a configuration of the household account server 11. One of the roles of the household account server 11 is to manage the household account information 12, at the same time, manages interactions with the account system 13, the information processing module 15, and the user terminal 8. For that purpose, the household account server 11 is provided with features that interact with these modules. As is shown in FIG. 5, the household account server 11 comprises an account information updating section 31 that reflects the information from the account system 13 in the household account information 12, and a user input assisting section 32 that manages interactions with the user terminal 8, wherein the user input assisting section 32 comprises a viewing and editing feature 33 and a notification feature 34. Furthermore, the household account server 11 comprises a household account information updating section 35 that interacts with the information processing module 15. These modules are independent in terms of operation, wherein portions that access the household account information 12 serving as a common database are associated with each other.

FIG. 6 is a flowchart showing a process of the account information updating section 31 shown in FIG. 5. First, the account information updating section 31 sets a target period to update the account information, on the basis of the date and time of the last update and the current date and time (step 101). Next, it sends the account system 13 the target period such as the date and time of the last update and the current date and time, and then requests transaction data for that period (items of the account information data shown in FIG. 4) (step 102). Then it determines whether an item to be updated exists (step 103), if so, it updates the household account information 12 on the basis of an item list for the obtained target period (step 104). If no items exist in step 103, then no update occurs and the account information updating section 31 sleeps until the next time of day (date) (step 105), then returning to the step 101 to do the same processing when the next time of day comes. In this way, according to the household account server 11 of the present invention, the account information updating section 31 determines the situation of items acquired from the account system 13 and updates the account information if an item to be updated exists. The updated account information is stored as the updated household account information 12 and provided to the user terminal 8 and the information processing module 15 as needed.

FIG. 7 is a diagram illustrating an outline of the user input assisting section 32 shown in FIG. 5. The user terminal 8 comprises a browser 36 that is used to view a home page or the like stored in the household account server 11, and a mail 37 that accepts a notification from the household account server 11, wherein a user can view and edit the household account information 12 using them. Specifically, the user terminal 8 sends a request for viewing and editing to the viewing and editing feature 33 of the household account server 11 through the browser 36. In response to this request, the viewing and editing feature 33 edits and updates the household account information 12. Further, the user requests the notification setting to the notification feature 34 of the household account server 11, using the browser. In response to this request, the notification feature 34 sets the notification conditions for the household account information 12. Thereafter, the notification feature 34 sends a notification to the user terminal 8 using a mail if the notification conditions are met.

FIG. 8 is a table showing instructions of the user input assisting section 32 in detail. Here are shown DB instructions corresponding to the SQL of database, wherein instructions are characterized by conditions and parameters at each type. A type “View” specifies conditions for an item subject to viewing, which corresponds to a “SELECT” statement of DB instructions. A type “change” specifies conditions for an item subject to change, which corresponds to an “UPDATE” statement of DB instructions, wherein a parameter is “pair of attribute and value” if a user rewrites a class by hand, for example. A type “delete” specifies conditions for an item subject to deletion, for example, a condition for deleting a specific item in the household account information 12, which corresponds to a “DELETE” statement of DB instructions. A type “notification setting” specifies condition and notification conditions of a target item, which corresponds to a “SET-TRIGGER” statement of DB instructions. IF the set notification conditions are met, the user terminal 8 issues a “notice” to the user terminal 8.

FIG. 9 depicts a configuration of the household account information updating section 35 shown in FIG. 5. The information processing module 15 in the service provider 10, as is shown if FIG. 1, or the information processing module 15 of the information processing company 20, which serves as a Web server via network such as the Internet, as is shown in FIG. 2 performs two kinds of processing, i.e., information acquisition and information update. As to the information acquisition, its request is sent to the household account information updating section 35 of the household account server 11, then the DB instruction “SELECT” shown in FIG. 8 is sent to the database that stores the household account information 12. Then, a set of resulting items is sent back to the information processing module 15 from the household account information updating section 35. On the other hand, as to the information update, the updated set of items are sent to the household account information updating section 35, which is transmitted to the database that stores the household account information 12 using a DB instruction “UPDATE” shown in FIG. 8.

FIG. 10 depicts a configuration of the information processing module 15 and an example of processing performed by it. The information processing module 15 performs processing for advertisement and publicity, for example. Here is shown an example which examines how to pay a telephone bill and advertises that the automatic debt transfer has an advantage over the payment at a convenience store. The information processing module 15 comprises an advertisement module 41, a statistics processing feature 42, and a database storing statistics information 43. The advertisement module 41 requests information from the household account server 11 to receive organized information and adds a new information about an advertisement. The statistics processing feature 42 puts together the information from the household account server 11 as the statistics information 43.

In the case of advertisement for automatic debt transfer of telephone bill, the advertisement module 41 first issues a request for information about the payment of telephone bill to the household account server 11. In response to this request, the result is sent to the statistics processing feature 42 and organized as the statistics information 43. That information is sent to the advertisement module 41 in an organized form, which tells, for example, that bills for “A” telephone company are often paid at a convenience store. The advertisement module 41 sends new information to the household account server 11 on the basis of benefit information that ““A” telephone company gives a discount for automatic debt transfer”. Specifically, an advertisement “A discount is granted for automatic debt transfer” is added to the “advertisement field” of an item ““A” telephone company convenience store” shown in FIG. 3. In response to this new information, the household account server 11 sends the added new information to the user terminal 8. Other advertisements are also contemplated, including for example, extracting the monthly balance or the kind of loan from the household account information 12, and offering a time deposit or refinance of a loan, respectively.

FIG. 11 is a flowchart illustrating an example of processing in adding advertisement information. First, the advertisement module 41 in the information processing module 15 requests information about payment to “A” telephone company from the household account server 11 (step 201). Next, it classifies and organizes the items acquired from the household account server 11 according to a method of payment (step 202). Then, it is determined whether the payment via convenience store is greater or equal to 50% (step 203). If so, an advertisement is added to the advertisement field of the target item, whereby the household account data is updated (step 204). If the payment at a convenience store is less than 50% in step 203, the processing ends. Note that the rate 50% used in the determination step 203 is simply one example, any other rate or criterion can be naturally used.

Now the input and output displays in the user terminal 8 will be described according to concrete examples.

FIG. 12 to FIG. 17 depict a processing screen displayed in the user terminal 8, wherein a household account system that interacts with a financial institute “XXX bank” serving as a service provider 10 is taken as an example.

FIG. 12 is a diagram showing a log-in screen of the household account system. A customer (user) views a home page of the household account server 11 using the browser 36 of the user terminal 8, and displays the log-in screen as shown in FIG. 12. In this example, a user can log in by entering a user ID and a password and then clicking a send button.

FIG. 13 is a diagram showing a sample display of the household account system at an initial stage after the log-in. Expenditure and income items are subdivided, wherein each class is shown in a hierarchical form with three stages. In addition to the account information from the bank accounts 14, there is shown an advertisement item such as “Automatic debt transfer saves you 10%, so please take advantage of this.”, which is generated by the information processing module 15. Furthermore, there are shown buttons under the display of the household accounts, which specify “Addition of item” and “Notification setting”. Clicking these buttons causes movement to a page for addition of items or notification setting.

FIG. 14 is a diagram showing a sample display of a page for addition of items, which is displayed by clicking the “Addition of item” button shown in FIG. 13. This function is utilized for inputting a subject to the acquired household account information 12, for example. In this example, date, item, expenditure, income, each class and method for payment can be added as an item.

FIG. 15 is a diagram showing a sample display of a page for setting notification conditions, which is displayed by clicking the “Notification setting” button shown in FIG. 13. In this setting of notification conditions, the notification conditions a user desires are set, such as “Inform if the telephone bill is transferred,” and “Inform if total expenditure becomes greater or equal to 150000 yen”. In FIG. 5, there are shown two kinds of notification conditions, i.e., “the setting for items” and “the setting for totals”. In the shown example, there is shown a situation where a user set such that a notice should be issued when “total expenditure” becomes greater or equal to “150000 yen” in relation to “the setting for totals”.

FIG. 16 is a diagram showing a situation where a notice is sent to the mail 37 in the user terminal 8 from the household account server 11, after setting the notification setting shown if FIG. 15. Here is shown a display to the effect that the “total expenditure” has become greater or equal to “150000 yen” and a URL that indicates a detailed page, which is hyperlinked.

FIG. 17 is a diagram showing a screen for notification of the condition setting, which is displayed by the specification of the hyperlink shown in FIG. 16. Here are shown the situation where the set conditions are met and the household account information at that time, as well as the conditions. In this way, setting the notification conditions so as to receive the notice from the service provider 10 when those conditions are met, a user can get the household account information whenever needed, without managing the household account information by himself.

As mentioned above, according to the present invention, in contrast with a conventional household account system that assumed to be used by a user personally, a user (customer) leaves his own household account information 12 with the service provider (financial institute) 10. As a result, a user (customer) is saved the trouble of data management and is freed from burdensome works such as software maintenance. Moreover, a user can acquire the household account information 12 with an added value such as an effective advertisement. On the other hand, the service provider (financial institute) 10 can utilize valuable information stored in the household account information 12 actively for the marketing such as an advertisement. For example, it can extract the monthly balance or the kind of loan from the household account information 12, and offer a time deposit or refinance of a loan, respectively. Further, according to the present invention, subdividing income and expenditure items allows improvement of convenience for a user, as well as an analysis by a service provider (financial institute) 10 from various points of view, thereby providing an effective scheme for both users and financial institutes.

It is noted that in the above embodiments of the present invention, an advertisement was used as an example of practical use of marketing in the information processing module 15, however, the present invention should not be limited to this. For example, it is preferred to provide an advice function as “household account diagnosis”, which offers a given advice to a user on the basis of the household account information 12. Moreover, it is also possible to provide effective investment information as a financial planner.

### Advantages of the Invention

As mentioned above, according to the present invention, a user (customer) is saved the trouble of management, leaving his own household account information with the server's side. In addition, a financial institution or the like corresponding to the server's side can make active use of customer's household account information for advertisement or the like.

### BRIEF DESCRIPTION OF THE DRAWINGS

FIG. 1 is a diagram illustrating a overall configuration of a household account system according to the present invention.

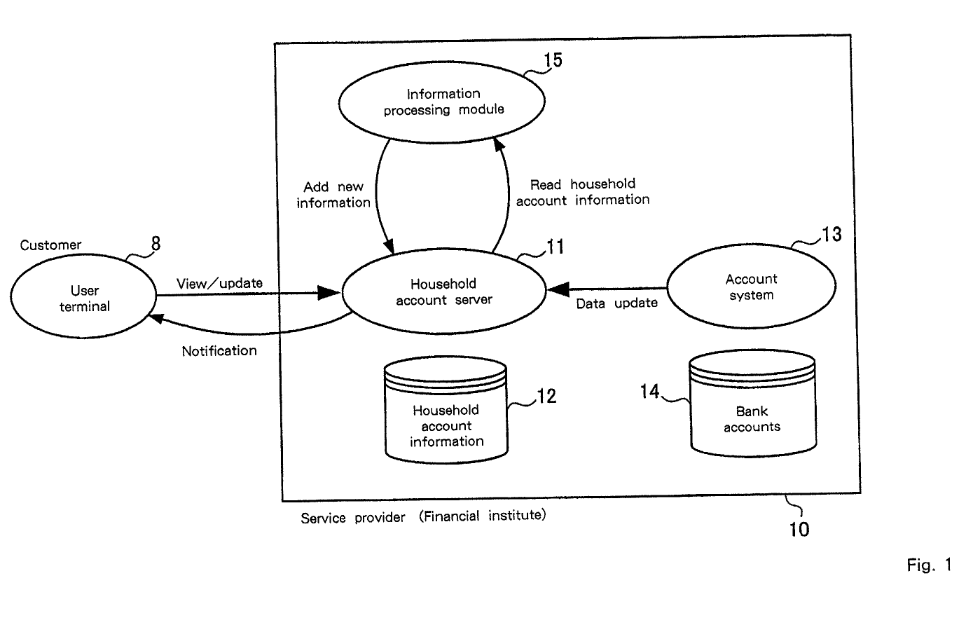

FIG. 2 is a diagram illustrating a modification of the household account system shown in FIG. 1.

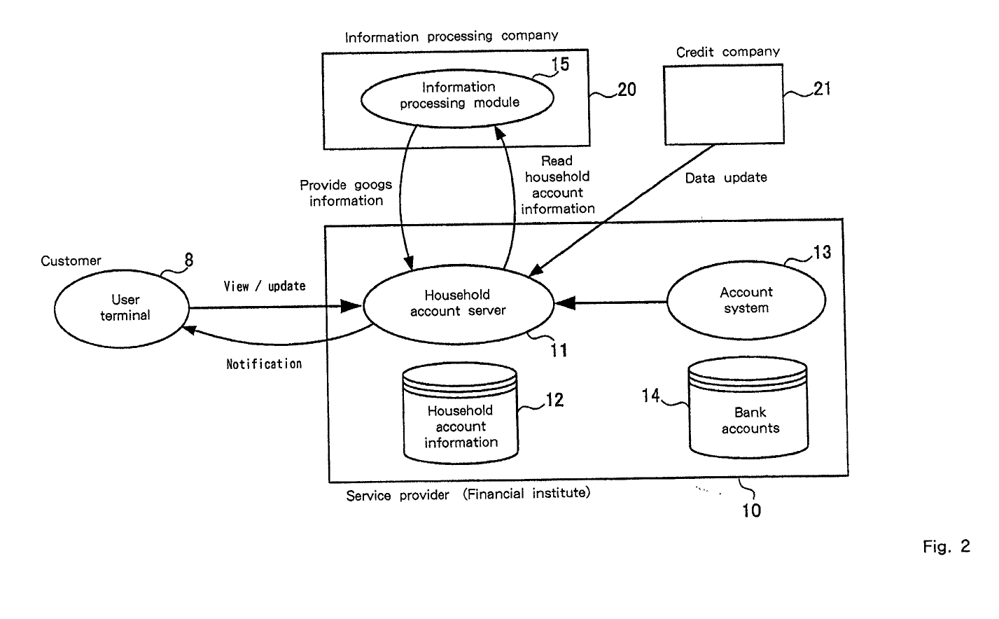

FIG. 3 depicts a data format of household account information stored in the household account information 12.

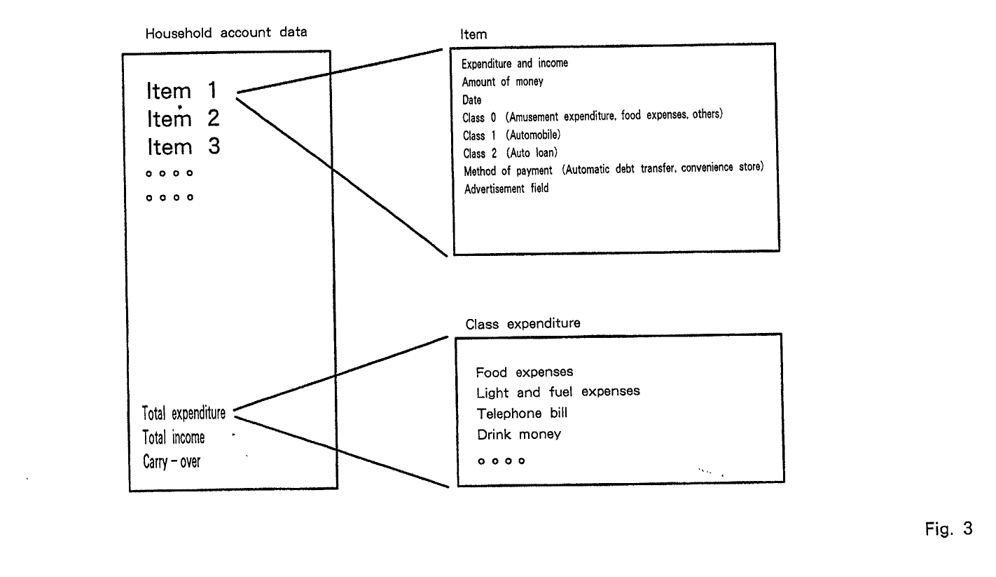

FIG. 4 depicts a data format of bank account information stored in the bank accounts 14.

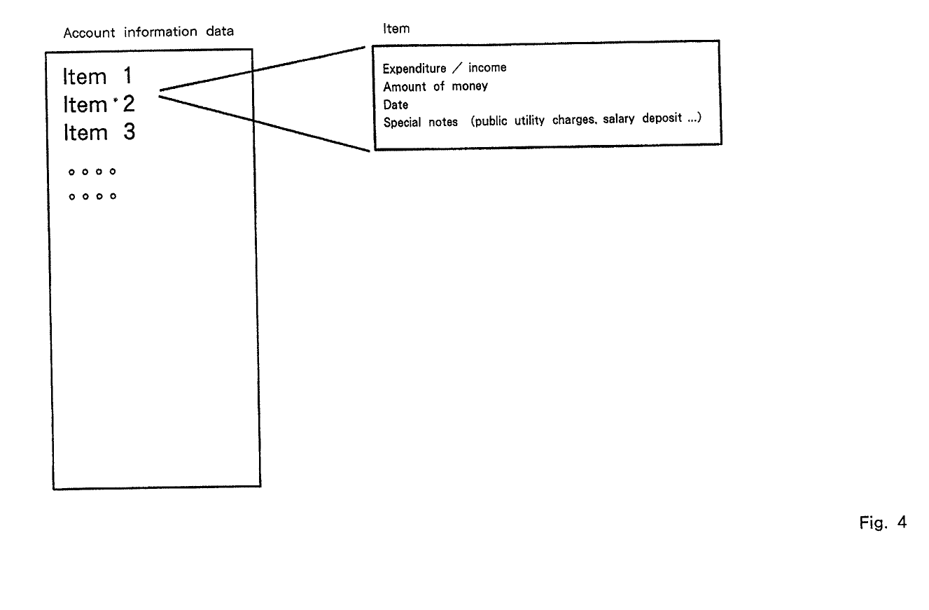

FIG. 5 depicts a configuration of the household account server 11.

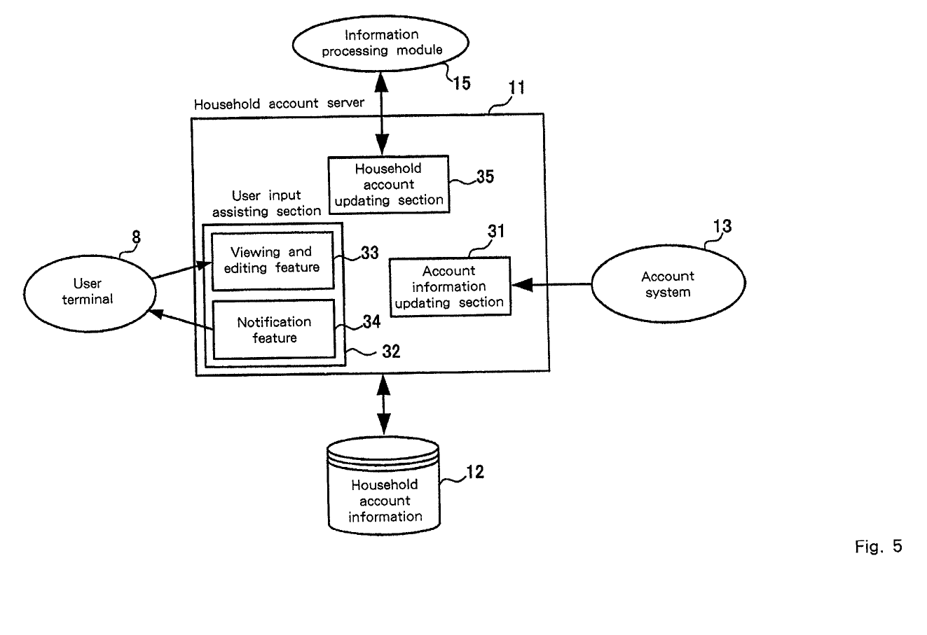

FIG. 6 is a flowchart showing a process of the account information updating section 31 shown in FIG. 5.

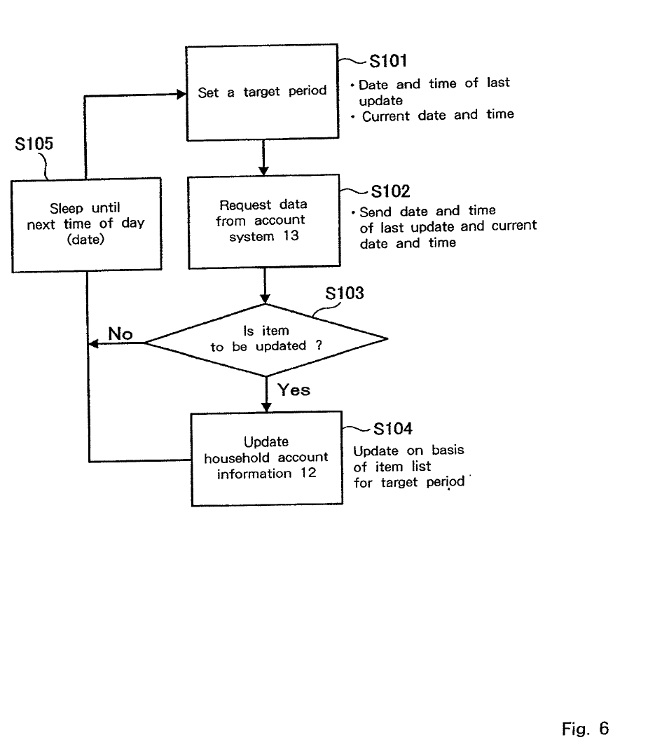

FIG. 7 is a diagram illustrating an outline of the user input assisting section 32 shown in FIG. 5.

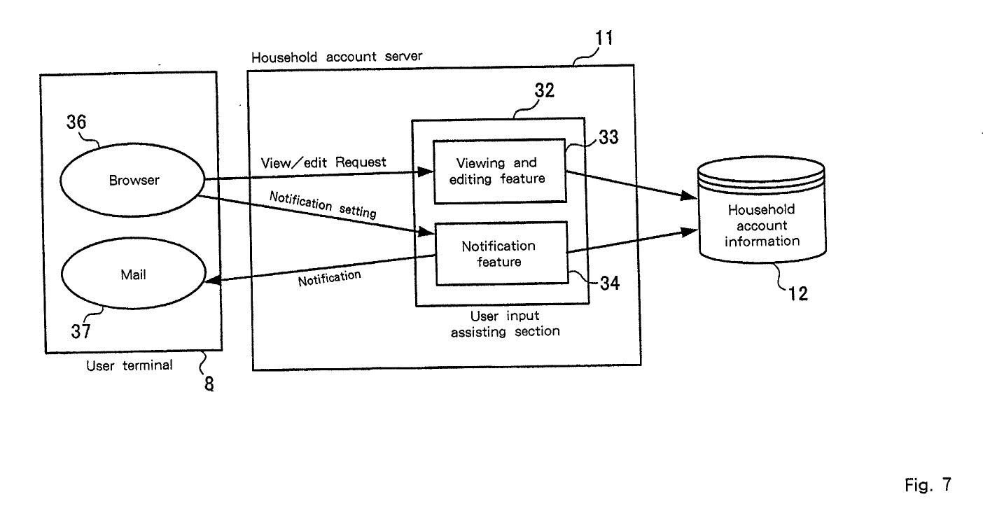

FIG. 8 is a table showing instructions of the user input assisting section 32 in detail.

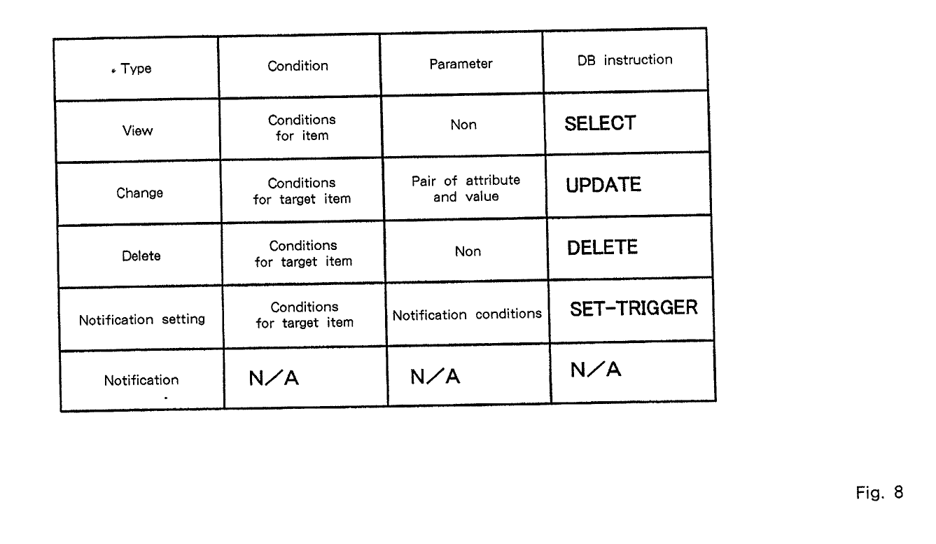

FIG. 9 depicts a configuration of the household account information updating section 35 shown in FIG. 5.

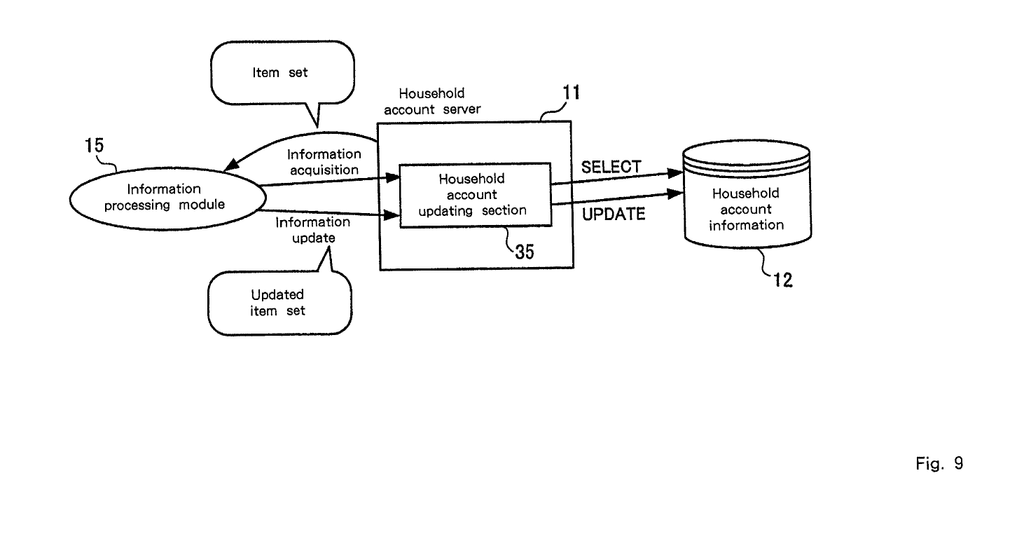

FIG. 10 depicts a configuration of the information processing module 15 and an example of processing performed by it.

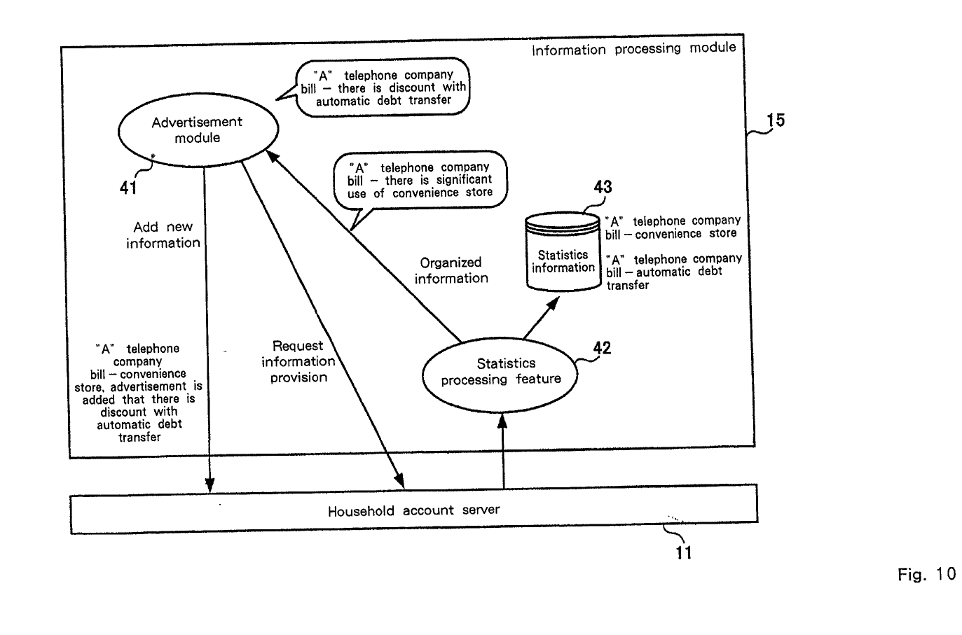

FIG. 11 is a flowchart illustrating an example of processing in adding advertisement information.

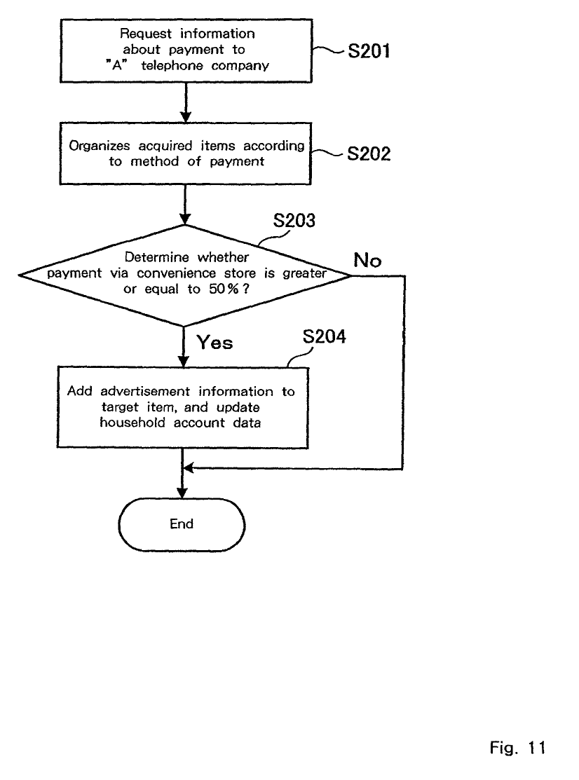

FIG. 12 is a diagram showing a log-in screen of the household account system.

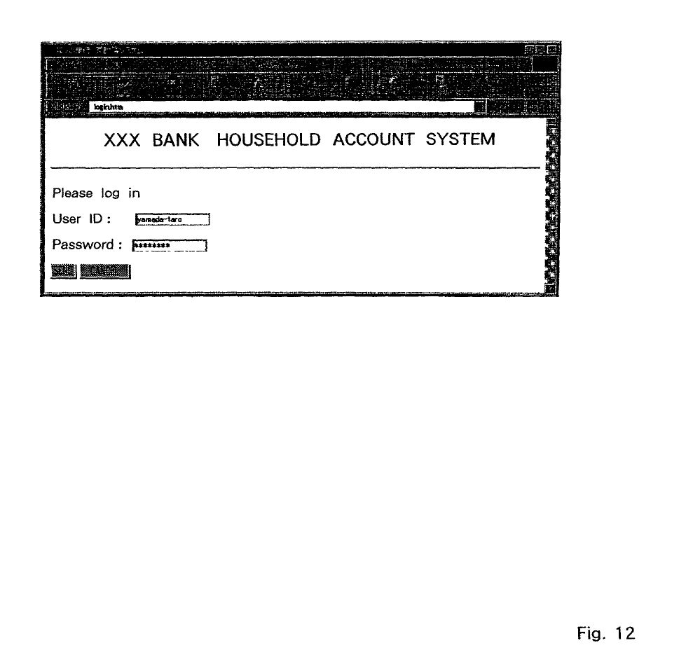

FIG. 13 is a diagram showing a sample display of the household account system at an initial stage after the log-in.

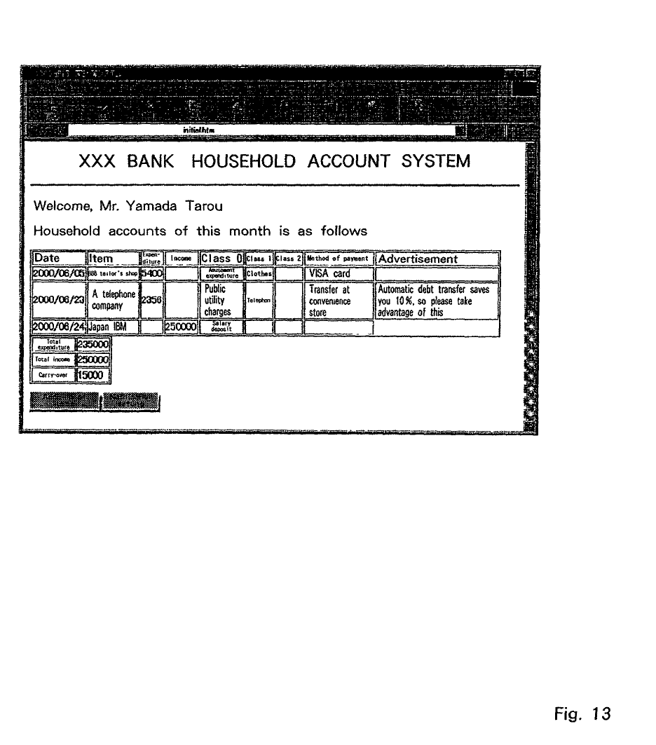

FIG. 14 is a diagram showing a sample display of a page for addition of items.

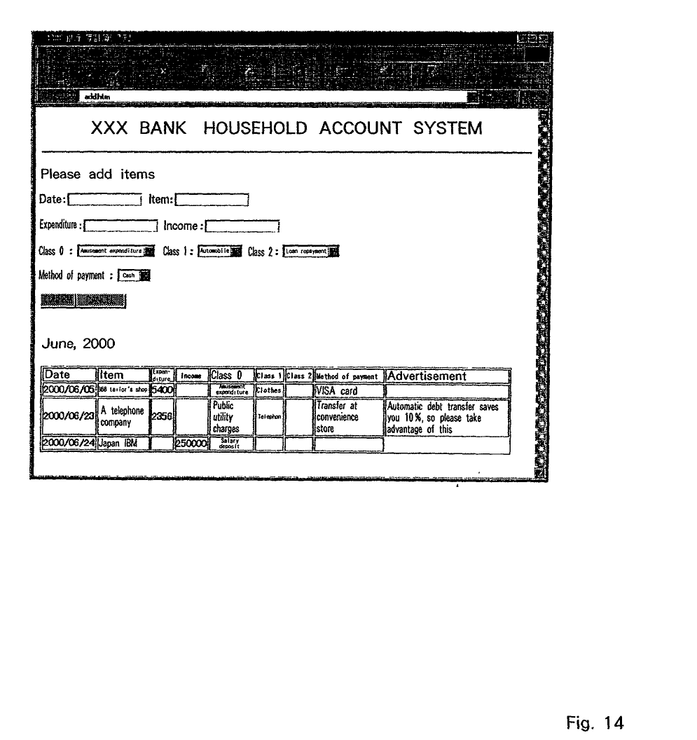

FIG. 15 is a diagram showing a sample display of a page for setting notification conditions.

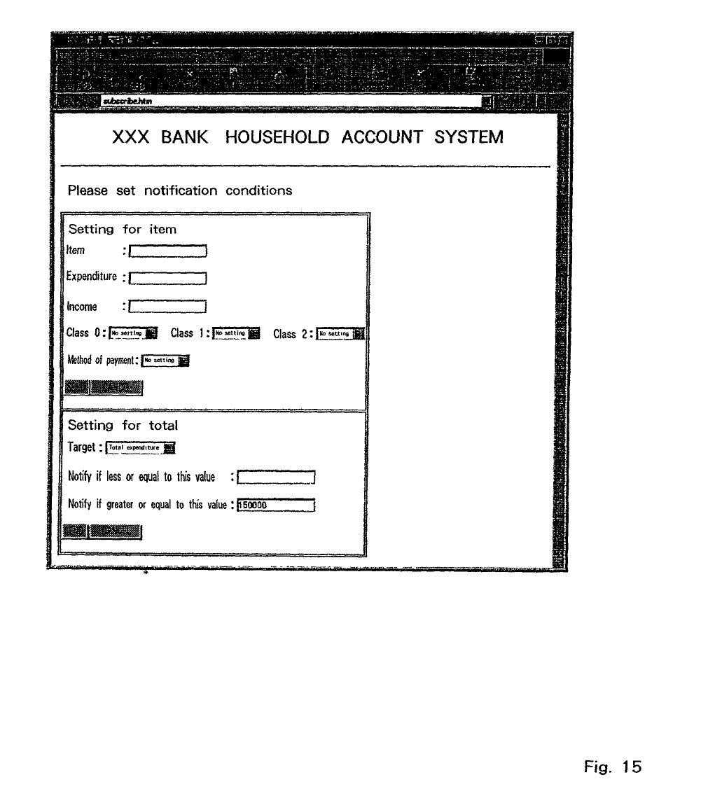

FIG. 16 is a diagram showing a situation where a notice is sent to the mail 37 in the user terminal 8 from the household account server 11, after setting the notification setting shown if FIG. 15.

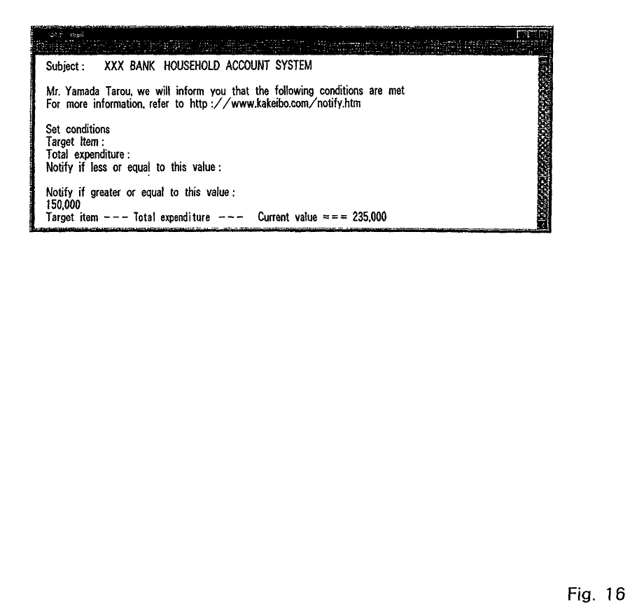

FIG. 17 is a diagram showing a screen for notification of the condition setting, which is displayed by the specification of the hyperlink shown in FIG. 16.

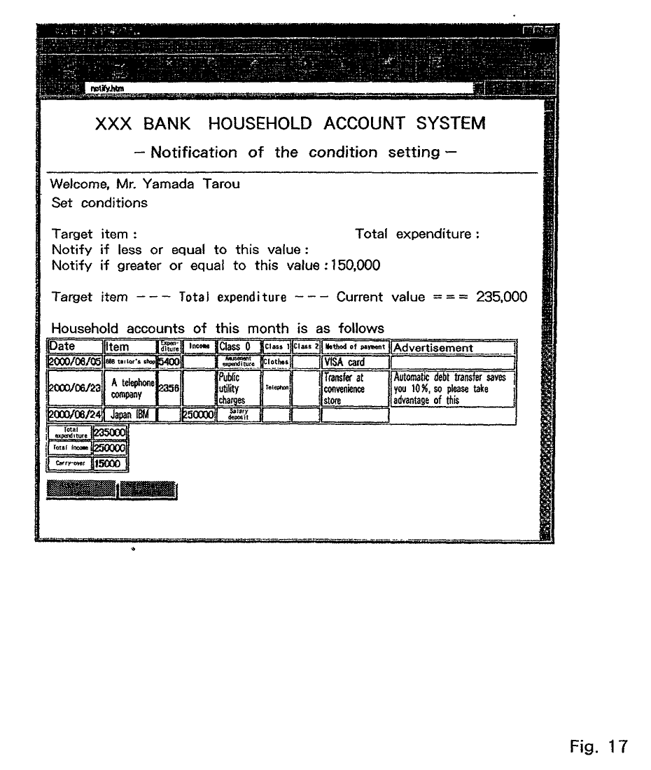

FIG. 18(a) and (b) is a diagram illustrating an outline of a conventional household account system.

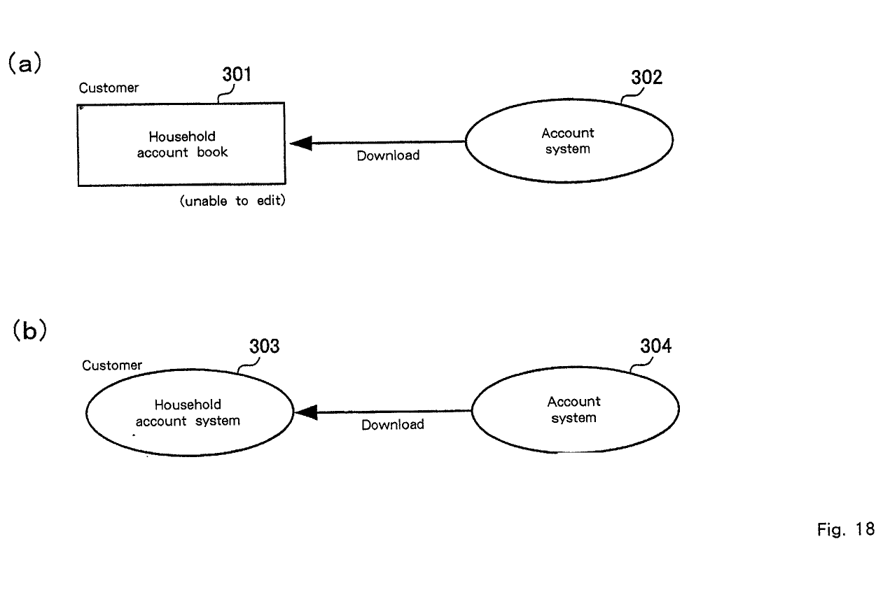

### DESCRIPTION OF THE SYMBOLS

8: User terminal

10: Service provider (Financial institute)

11: Household account server

12: Household account information

13: Account system

14: Bank accounts

15: Information processing module

20: Information processing company

21: Credit company

31: Account information updating section

32: User input assisting section

33: Viewing and editing feature

34: Notification feature

35: Household account updating section

36: Browser

37: Mail

41: Advertisement module

42: Statistics processing feature

43: Statistics information

1. A hosting service system of household account information, comprising:
a user terminal connected to a network; and
a service provider connected to said network for providing said user terminal with household account information including a plurality of items for each user,
wherein said service provider adds additional information to predetermined items in the household account information of each user and provides to said user terminal, wherein the additional information is based on the analysis results regarding said household account information.

2. The hosting service system according to claim 1, further comprising:
an information processing module □□ for analyzing said household account information and providing additional information based on the analysis results.

3. The hosting service system according to claim 2, wherein said information processing module is provided by an information processing company that is connected to said service provider over a network.

4. The hosting service system according to claim 1, wherein the household account information provided by said service provider has its contents of a plurality of items updated on the basis of a change of contents in bank account information of each user.

5. The hosting service system according to claim 1, wherein said service provider provides household account information, wherein income and expenditure items are subdivided on the basis of a request from said user terminal, and sends a predetermined notice to said user terminal on the basis of set notification conditions from said user terminal.

6. A household account server for providing household account information to a user terminal connected to a network, comprising:
an account information updating feature for updating account information in response to update of bank account data and reflecting in the household account information;
an information adding feature for adding information to the household account information in response to additional information about marketing; and
a notification feature for notifying the account information updated by said account information updating feature and the information added by said information adding feature to said user terminal.

7. The household account server according to claim 6, further comprising:
an information processing module for analyzing said household account information and generating additional information about an advertisement, wherein said information adding feature adds the information generated by said information processing module to said household account information.

8. The household account server according to claim 6, wherein said information adding feature adds information about an advertisement that is created by an external institute connected via network as analysis results of said household account information to said household account information.

9. An account information providing server for providing managed account information to a user terminal connected to a network, comprising:
view request accepting means for accepting a view request from said user terminal;
notification conditions accepting means for accepting the setting of notification conditions from said user terminal; and
account information providing means for providing the account information to said user terminal on the basis of the view request accepted by said notification conditions accepting means and for providing the account information to said user terminal if it matches the notification conditions accepted by said notification conditions accepting means.

10. The account information providing server according to claim 9, further comprising:
adding means for adding advertisement information to the account information as a result of an analysis of said account information, wherein said account information providing means provides the account information added with said advertisement information to said user terminal.

11. A household account information processing server, comprising:
acquiring means for acquiring household account information from a server that holds household account information;
analyzing means for analyzing said acquired household account information;
determining means for determining additional information to be added to said household account information on the basis of analysis results by said analyzing means; and
output means for outputting said additional information determined by said determining means to said server.

12. A method for providing household account information to a user terminal connected to a network using the network, comprising the steps of:
generating household account information on the basis of bank account information of each user;
adding additional information to items held by said household account information, wherein the additional information is based on an analysis of said generated household account information; and
providing said household account information with the items of said additional information added to said user terminal.

13. The method according to claim 12, wherein the step of generating household account information further comprising the step of:
subdividing income and expenditure items from said bank account information to generate household account information; and
providing said generated household account information to said user terminal on the basis of a view request from said user terminal.

14. The method according to claim 12, further comprising the steps of:
accepting notification conditions set by said user terminal; and
sending a notice to said user terminal if said household account information matches said accepted notification conditions.

15. The method according to claim 12, further comprising the steps of:
providing said household account information to a information processing company connected over a network;
receiving advertisement information generated by said information processing company on the basis of an analysis of said household account information; and
adding said received additional information to items held by said household account information.

16. The method according to claim 12, further comprising the steps of:
acquiring information from other financial institutions over a network; and
generating household account information on the basis of said acquired information.

17. A storage medium storing a program readable by input means of a computer and executed by the computer, the program comprising:
processing for generating household account information, wherein income and expenditure items are subdivided on the basis of bank account information;
processing for adding additional information to said household account information on the basis of an analysis of said generated household account information; and
processing for providing said household account information with said additional information added to said user terminal.

18. The storage medium according to claim 17, the program further comprising:
processing for accepting notification conditions from said user terminal; and
processing for sending a notice to said user terminal if said household account information matches said accepted notification conditions.

19. A storage medium storing a program readable by input means of a computer and executed by the computer, the program comprising:
processing for acquiring household account information from a household account server that holds household account information;
processing for analyzing said acquired household account information;
processing for determining additional information to be added to said household account information on the basis of analysis results; and
processing for outputting said determined additional information to said household account server.
